(19) United States
(12) Patent Application Publication
(10) Pub. No.: US 2011/0272838 A1
(43) Pub. Date: Nov. 10, 2011

(54) Apparatus, System, and Method for Nanoimprint Template with a Backside Recess Having Tapered Sidewalls

(76) Inventors: Matt Malloy, Albany, NY (US); Abbas Rastegar, Schenectady, NY (US); Lloyd C. Litt, Latham, NY (US)

(21) Appl. No.: 12/775,355

(22) Filed: May 6, 2010

(51) Int. Cl. B29C 59/02; B29C 33/72; B29C 33/38; B29C 59/00; B29C 35/08

(52) U.S. Cl. 264/39; 425/470; 425/385; 425/174.4; 264/219

(57) ABSTRACT

An apparatus, system, and method for nanoimprint templates with a backside recess having tapered sidewalls. In some embodiments, the nanoimprint templates comprise a support structure having a top surface, a bottom surface, and a recess in the top surface. The recess may have an inwardly tapered sidewall extending from the top surface to a floor of the recess. The template may further comprise a mold on the bottom surface.

### BACKGROUND OF THE INVENTION

1. Field of the Invention

This invention relates to nanoimprint templates and more particularly relates to an apparatus, system, and method for a nanoimprint template having a backside recess with curved or sloped sidewalls.

2. Description of the Related Art

Nanoimprint lithography is a process by which a pattern having small features may be transferred from a template to a substrate. For example, nanoimprint lithography is used in the semiconductor industry to form features on the surface of a silicon wafer. The process may start by forming a layer of a moldable material on a substrate. Two examples of moldable materials that may be used are a thermoplastic or a photo-curable liquid resist (“photoresist”). When a thermoplastic is used, the thermoplastic is heated and then the template is pressed into it to transfer the pattern. When an imprintable photoresist is used, the template is pressed into the material while it is in a liquid form, and then a UV exposure is used to cure the material in the patterned form.

One common problem with nanoimprint lithography is that air may get trapped in the moldable material, between the template and substrate, when the template is pressed into it. One solution to this problem has been to press the template onto the moldable material at an angle, so as to allow air to escape in a preferential direction as the template makes contact with the moldable material. Another method has been to make the surface of the template relatively thin and to bow it out before the template makes contact with the moldable material. This style of template is sometimes referred to as a backside core-out template since the backside of the template is hollowed out to form the thin surface. Current backside core-out templates have vertical sidewalls forming a ninety degree angle with the front surface of the template. By bowing out the surface of the template, the center of the template makes contact with the moldable material first, allowing air to escape radially starting at the center. The bowing method is an efficient way to prevent air from being trapped. Between uses, nanoimprint templates must be cleaned and dried.

### SUMMARY OF THE INVENTION

An apparatus for a nanoimprint template with a backside recess with tapered sidewalls is presented. In one embodiment, the apparatus includes a support structure having a top surface, a bottom surface, and a recess in the top surface. The recess has an inwardly tapered sidewall extending from the top surface to a floor of the recess. The apparatus also has a mold on the bottom surface. In some embodiments, the nanoimprint template may have a tapered sidewall that is substantially straight.

In some embodiments, the nanoimprint template may have a tapered sidewall that is substantially curved. The tapered sidewall may be curved at the floor of the recess. In some embodiments, the sidewall may be curved at a top edge of the nanoimprint template. The tapered sidewall may also be curved at the floor of the recess and the top edge of the nanoimprint template.

In some embodiments, the support structure and the mold comprise one material. For example, the template and mold may both be comprised of quartz.

In some embodiments, the tapered sidewall is at least five percent longer than the depth of the recess. In some embodiments, the tapered sidewall is at least ten percent longer than the depth of the recess. In yet other embodiments, the tapered sidewall is at least 20 percent longer than the depth of the recess.

Also presented is a system for forming a nanoimprint structure. The system comprises a first chuck for holding a substrate, a second chuck for holding a nanoimprint template, and a press. In some embodiments, the nanoimprint template comprises a support structure having a top surface, a bottom surface, a recess having an inwardly tapered sidewall extending from the top surface to a floor of the recess, and a mold on the bottom surface. In some embodiments, the press is configured to contact the substrate with the mold.

In some embodiments, the system for forming a nanoimprint structure also includes an energy source. In some embodiments, the energy source is a heater that is configured to heat the top surface of the substrate. In some embodiments, the energy source is a UV-light source and is configured to shine light onto the substrate.

In some embodiments the first chuck is stationary relative to the press. In this embodiment, the second chuck may be moved relative to the press, which may cause the mold to contact the substrate. In some embodiments, the second chuck may be stationary. In this embodiment, the first chuck may be caused to move relative to the press, which may then cause the mold to contact the substrate.

A method is also presented for making a nanoimprint template having a backside recess with tapered sidewalls. The method in the disclosed embodiments substantially includes the steps necessary to carry out the functions presented above with respect to the operation of the described apparatus and system. In one embodiment, the method includes forming a mold on a bottom surface of a nanoimprint template, and forming a recess having an inwardly tapered sidewall extending from a top surface of the nanoimprint template to a floor of the recess.

In one embodiment, forming the mold may comprise removing material from the bottom surface of the nanoimprint template. In one embodiment, forming the recess may comprise removing material from the top surface of the support structure.

In one embodiment, forming the recess may comprise forming a sidewall that is substantially straight. In some embodiments, forming the recess may comprise forming a sidewall that is curved at the top surface. In some embodiments forming the recess may comprise forming a sidewall that is curved at the floor of the recess. In some embodiments forming the recess may comprise forming a sidewall that is at least five percent longer than the depth of the recess.

A method is also presented for cleaning a nanoimprint template. The method may include dispensing a cleaning material onto a nanoimprint template. The nanoimprint template may have a recess having an inwardly tapered sidewall extending from a top surface of the support structure to a floor of the recess. The method may also include removing the cleaning material from the template by spinning the template around its center axis. The spinning of the template may cause the cleaning materials, and any other residue that may be in the recess, to be expelled. Spinning may cause a centrifugal force that may cause material to travel to the perimeter of the nanoimprint template. As the residue encounters the tapered wall, it may be directed out and away from the nanoimprint template. The method may also include blowing compressed air or gas into the center of the nanoimprint template. The air may cause the cleaning material to evaporate and it may also push the cleaning material and/or residue along the surface of the recess and along the tapered wall. Additionally, the method may include applying heat to the nanoimprint template to accelerate the evaporation of the cleaning material and/or residue.

The term “inwardly tapered” is defined as a taper or slope that is between the perimeter of a nanoimprint template and a center of the nanoimprint template. In a nanoimprint template having a recess in a top surface, the taper slopes from a first point to a second point, where the first point is defined as being: 1) closer to the top of the nanoimprint template than the second point, and 2) closer to the perimeter of the nanoimprint template than the second point.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a schematic block diagram illustrating a cross section of one embodiment of a nanoimprint template having a recess with substantially straight sidewalls.

FIG. 2 is a schematic block diagram illustrating a cross section of one embodiment of a nanoimprint template having a recess with substantially curved sidewalls.

FIG. 3 is a schematic block diagram illustrating a top view of one embodiment of a nanoimprint template.

FIG. 4 is a schematic block diagram illustrating a system having a nanoimprint template with a backside recess having tapered walls.

### DETAILED DESCRIPTION

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

On advantageous feature of some embodiments is improved cleaning and drying of the nanoimprint templates between uses. One method of cleaning is to use an automated cleaning tool which dispenses cleaning materials in a safe and controlled manner and dries the template by spinning it around its central axis. Tapered sidewalls can give improved performance over vertical sidewalls because tapered sidewalls can prevent cleaning materials from becoming trapped in the recess. Residual liquids or other materials remaining after cleaning may adversely affect subsequent processes and may damage tools. Increased down-time due to long drying times also decreases process throughput and increases cost. Therefore, tapered sidewalls may reduce damage due to residual materials and may decrease the time between uses.

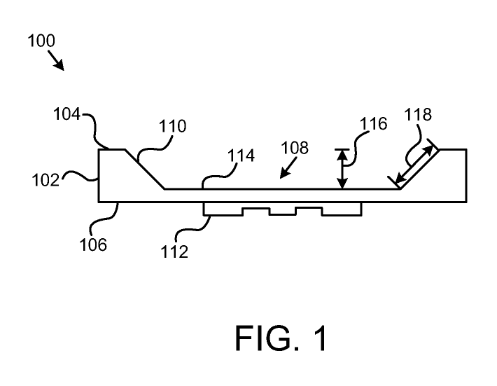

FIG. 1 illustrates a cross sectional view of one embodiment of a nanoimprint template 100 with a backside recess 108 having tapered sidewalls 110. The nanoimprint template 100 includes a support structure 102 and a mold 112. In this embodiment, the support structure 102 has a top surface 104 and a bottom surface 106. The mold 112 is formed on the bottom surface 106. In some embodiments, the support structure 102 and the mold 112 are formed from a common piece of material. For example, a piece of quartz may be used to form the nanoimprint template 100.

The terms “top surface” and “bottom surface” have been used for the purpose of distinguishing two surfaces according to one embodiment and should not be interpreted to mean that a template according to the present disclosure must be used in a particular orientation. One of ordinary skill will recognize embodiments where the template may be flipped or turned such that the “top surface” is not necessarily at a higher altitude than the bottom surface.

Nanoimprint template 100 has a recess 108 on the top surface 104. The recess 108 comprises tapered sidewalls 110 that extend inwardly from the outside edges of the nanoimprint template 100. The tapered sidewalls 110 contact the floor 114 of the recess 108. The floor 114 of the recess 108 may be substantially straight or may be curved. In some embodiments, the length 118 of the tapered sidewalls 110 is more than five percent longer than the depth 116 of the recess 108. The depth 116 of the recess 108 is the distance from the top surface 104 of the nanoimprint template 100 to the floor 114 of the recess 108 as measured perpendicularly (normal) to the top surface 104. The length 118 of the sidewall 110 is the shortest distance along the sidewall between the top surface 104 and the floor 114 of the recess 108. Nanoimprint template 100 may be used, for example, in a Molecular Imprints Imprio 300 Nanoimprint Lithography system.

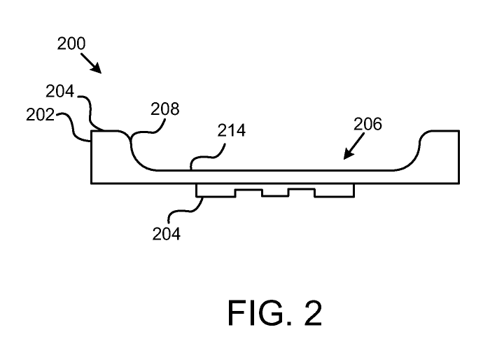

FIG. 2 illustrates a cross sectional view of one embodiment of a nanoimprint template 200 having a substantially tapered sidewall 208. The nanoimprint template 200 comprises a support structure 202 and a mold 204. The recess 206 is formed in the support structure and is characterized by a tapered sidewall 208. In the embodiment shown, the tapered sidewall 208 is curved both at the floor 214 of the recess 206 and the top surface 204. In some embodiments, the tapered sidewall 208 may be curved at the floor 214 of the recess 206 and substantially straight at the top surface 204. Alternatively, the tapered sidewall 208 may be curved at the top surface 204 and substantially straight at the floor 214 of the recess 206.

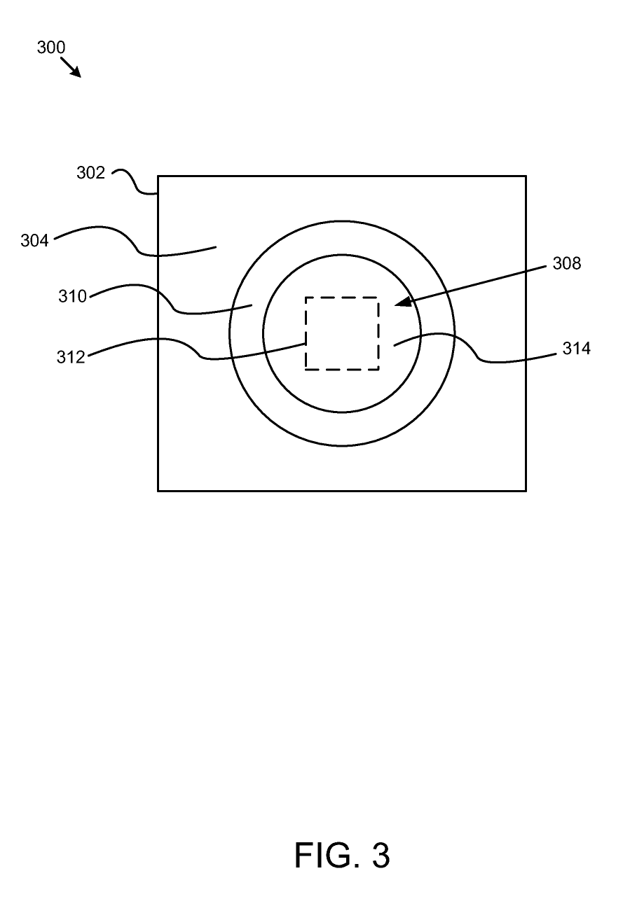

FIG. 3 illustrates a top view of a nanoimprint template 300. The support structure 302 has a backside recess 308. The backside recess 308 has a tapered sidewall 310 extending inwardly from the top surface 304 to the floor 314 of the recess 308. On the bottom surface of the nanoimprint template 300 is a mold 312.

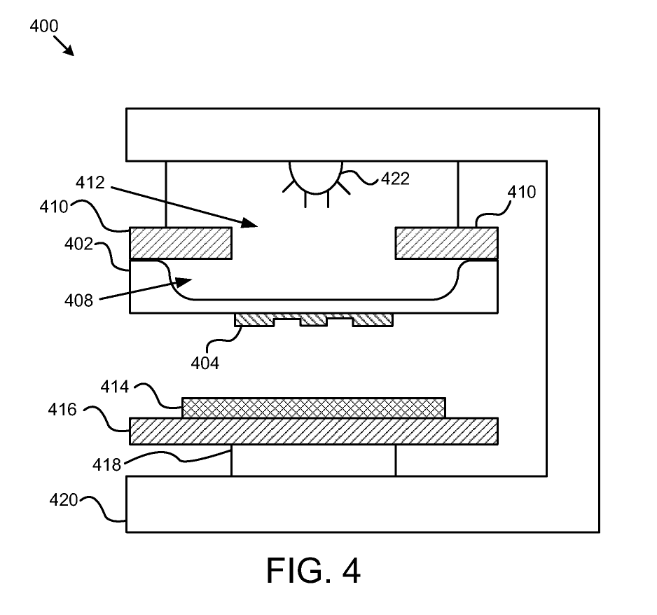

FIG. 4 illustrates a cross sectional view of a system 400 for nanoimprint lithography. The system 400 has a support structure 402 that has a backside recess 408. The support structure 402 is coupled to a mold 404 on the bottom side and a second chuck 410 on the top side. The second chuck 410 is configured to make a seal around the recess 408 in the support structure 402. The second chuck 410 may be made out of metal, such as stainless steel. In some embodiments, gas may be pumped into the recess 408 through the gas inlet 412. The result of pumping gas into the recess 408 is that the mold 404 may bow out, improving the performance of the mold 404. For example, bowing the mold 404 out while contacting the mold with the substrate 414 will prevent air from becoming trapped between mold 404 and substrate 414.

The second chuck is coupled to the nanoimprint press 420. The press 420 may include a piston 418. The piston 418 is coupled to the first chuck 416. The first chuck 416, in turn, is coupled to the substrate 414. In some embodiments, the piston 418 may provide the force necessary to contact the substrate 414 and the mold 404. In this embodiment, the second chuck 410 may be stationary in relation to the press 420. In other embodiments, the first chuck 416 may be stationary and force may be applied to the second chuck 410.

In some embodiments the system 400 may include an energy source 422. The energy source 422 may be a light source, such as a UV light source, that is configured to shine light onto or through the mold. The energy source 422 may also be a heat source. UV light and heat are sometimes used to cure a moldable material such as a UV-curable photoresist.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

What is claimed is:

1. An nanoimprint template comprising:
a support structure having a top surface, a bottom surface, and a recess in the top surface, the recess having an inwardly tapered sidewall extending from the top surface to a floor of the recess; and
a mold on the bottom surface.

2. The nanoimprint template of claim 1, where the tapered sidewall is substantially straight.

3. The nanoimprint template of claim 1, where the tapered sidewall is substantially curved.

4. The nanoimprint template of claim 3, where the tapered sidewall is curved at the floor of the recess.

5. The nanoimprint template of claim 3, where the tapered sidewall is curved at a top edge of the nanoimprint template.

6. The nanoimprint template of claim 1, where the support structure and mold comprise one material.

7. The nanoimprint template of claim 1, where the tapered sidewall is at least five percent longer than the depth of the recess.

8. A system comprising:
a first chuck for holding a substrate;
a second chuck for holding a nanoimprint template, the nanoimprint template comprising:
a support structure having a top surface, a bottom surface, and a recess having an inwardly tapered sidewall extending from the top surface to a floor of the recess;
a mold on the bottom surface; and
a press configured to contact the substrate with the mold.

9. The system of claim 8, further comprising a heater configured to heat the substrate.

10. The system of claim 8, further comprising a radiation source configured to shine light onto the substrate.

11. The system of claim 8, where the first chuck is stationary.

12. The system of claim 8, where the second chuck is stationary.

13. The system of claim 8, where the tapered sidewall is at least five percent longer than the depth of the recess.

14. A method for manufacturing a nanoimprint template, the method comprising:
forming a mold on a bottom surface of a support structure; and
forming a recess having an inwardly tapered sidewall extending from a top surface of the support structure to a floor of the recess.

15. The method of claim 14, where forming the mold comprises removing material from the bottom surface of the support structure.

16. The method of claim 14, where forming the recess comprises removing material from the top surface of the support structure.

17. The method of claim 14, where forming the recess comprises forming a sidewall that is substantially straight.

18. The method of claim 14, where forming the recess comprises forming a sidewall that is curved at the top surface.

19. The method of claim 14, where forming the recess comprises forming a sidewall that is curved at the floor of the recess.

20. The method of claim 14, where forming the recess comprises forming a sidewall that is at least five percent longer than the depth of the recess.

21. A method for cleaning a nanoimprint template, the method comprising:
dispensing a cleaning material onto a nanoimprint template, where the nanoimprint template comprises a recess having an inwardly tapered sidewall extending from a top surface of the support structure to a floor of the recess;
removing the cleaning material from the template by spinning the template around its center axis, wherein the cleaning materials are expelled along the tapered sidewall by centrifugal force.
